(19) United States
(12) Patent Application Publication
(10) Pub. No.: US 2026/0015209 A1
(43) Pub. Date: Jan. 15, 2026

(54) LONGITUDINALLY DIVISIBLE LATTICE PIECE

(71) Applicant: Liebherr-Werk Ehingen GmbH, Ehingen (DE)

(72) Inventors: Julian BRUGGER, Ehingen (DE); Ulrich WIEDEMANN, Ulm (DE); Alex FISCHER, Laupheim-Baustetten (DE)

(21) Appl. No.: 19/226,984

(22) Filed: Jun. 3, 2025

(30) Foreign Application Priority Data
Jun. 3, 2024 (DE) 10 2024 115 379.2

(51) Int. Cl. B66C 23/70

(52) U.S. Cl. CPC B66C 23/70

(57) ABSTRACT

The invention relates to a longitudinally divisible lattice piece for a lattice boom, comprising two detachably connectable lattice piece parts that can be detached from one another for transport and pushed into one another transversely to the longitudinal direction, wherein each of the lattice piece parts comprises two corner posts extending in the longitudinal direction, which are firmly connected to one another via a plurality of diagonal and vertical bars and together with these define a side surface of the lattice piece, and at least two cross-connecting structures firmly connected to the corner posts, wherein the lattice piece parts can be detachably connected via connection means arranged on the cross-connecting structures.

### CROSS REFERENCE TO RELATED APPLICATION

The present application claims priority to German Patent Application No. 10 2024 115 379.2 filed on Jun. 3, 2024. The entire contents of the above-listed application are hereby incorporated by reference for all purposes.

### TECHNICAL FIELD

The present invention relates to a longitudinally divisible lattice piece and to a lattice boom and a working machine having such a lattice boom.

### BACKGROUND

It is known from the prior art that lattice pieces for lattice booms, such as those used as crane booms for mobile cranes, can be divided longitudinally in order to provide a wider lattice boom with increased lateral rigidity, at least in sections, for crane operation, but to achieve a smaller width for transport in a transport position in order to comply with legal requirements regarding maximum permissible transport dimensions.

### SUMMARY

An example of such a longitudinally divisible lattice piece is known from DE 10 2017 000 525 A1. The solution presented here is based on two lattice piece parts with an L-shaped cross-section, wherein one of the lattice piece parts is rotated by 180° to produce a widened lattice piece. The widened lattice piece then has an open side, which must be closed or bridged using separate lattice elements. These must therefore be kept separately, which increases storage and assembly costs.

The object of the present invention is to provide a generic lattice piece, the conversion of which between a widened operating position and a transport position reduced in width requires less assembly work and, in particular, has increased stability.

According to the invention, this object is achieved by a longitudinally divisible lattice piece as described herein.

According to the invention, a longitudinally divisible lattice piece for a lattice boom is proposed, which comprises two detachably connectable lattice piece parts that can be detached from each other for transport and pushed into each other transversely to the longitudinal direction in order to achieve a transport position with a reduced width. Each of the lattice piece parts comprises two corner posts extending in the longitudinal direction, which are firmly connected, in particular welded, to one another via a plurality of diagonal and vertical bars and, together with the corner posts, define an (imaginary) side surface of the lattice piece, as well as at least two cross-connecting structures firmly connected, in particular welded, to the corner posts. Connection means are located on the cross-connecting structures, via which the lattice piece parts can be detachably connected to each other. When connected, these connection means form the cross-connections of the lattice piece parts.

The cross-connecting structures connect the side surfaces formed by the corner posts in the assembled lattice piece (operating state) and define the overall width of the assembled lattice piece (“assembled” always refers to the operating state of the lattice piece in which the lattice piece parts are connected to each other at the connecting means). In particular, this overall width is above a specified transport width (of 3.5 metres, for example). The cross-connecting structures are designed in such a way that they enable the lattice piece parts that have been separated from each other to be pushed into each other transversely to the longitudinal direction (i.e. in the width direction), which reduces the overall width of the lattice piece in the transport position and thus a specified transport width can be maintained (e.g. the overall width in the transport state can be less than 3.5 metres). The cross-connecting structures are part of the respective lattice piece parts and, in particular, do not represent structures that have to be provided separately, which reduces the assembly effort.

According to the invention, the cross-connecting structures each comprise at least two leg bars firmly connected to an upper corner post of a lattice piece part and at least two leg bars firmly connected to a lower corner post of the lattice piece part, which together with the respective corner post define an upper and a lower (imaginary) cover surface of the lattice piece. The upper cover surface of a cross-connecting structure is thus formed in particular by the upper leg bars and the upper corner post, while the lower cover surface is formed by the lower leg bars and the lower corner post.

According to the invention, the upper and/or the lower cover surface of each cross-connecting structure is inclined relative to an (imaginary) plane perpendicular to the side surface towards the other cover surface. The upper and/or lower cover surfaces are therefore not perpendicular to the side surface spanned by the corner posts, but run at an angle or incline, so that the height of the cross-connecting structures is reduced in the direction of the other lattice piece part.

In addition, the leg bars are connected to each other via at least one longitudinal bar running parallel to the corner posts in order to increase the stability of the assembled lattice piece and reduce the buckling length of the corner posts. The longitudinal bars of the lattice piece parts (each of the lattice piece parts has at least one such longitudinal bar, preferably two longitudinal bars each, namely one on the lower and one on the upper leg bars) preferably run outside the cover surfaces, i.e. in particular are attached to the outside of the leg bars. The inclination of the upper and/or lower cover surfaces now makes it possible to slide the cross-connecting structures into each other for transport without them colliding with the aforementioned longitudinal bars. This provides a lattice piece with increased stability that is easy to connect or divide and the transport width of which can be effectively reduced.

In particular, the longitudinal bars extend along the entire length of the lattice piece parts and connect not only the upper or lower leg bars of a cross-connecting structure, but all cross-connecting structures with each other. This effectively reduces the buckling length of the corner posts.

The aforementioned side surfaces are spanned in particular by the imaginary central longitudinal axes of the corner posts. The imaginary central longitudinal axes of the diagonal and vertical bars, which connect the corner posts of a lattice piece part, are in particular also located within the side surface. In particular, the upper and lower cover surfaces are spanned by the imaginary central longitudinal axes of the upper and lower leg bars and the upper and lower corner posts.

Preferably, the corner posts and leg bars and, in particular, the diagonal and vertical bars are designed as tubes. These can, but do not have to, have a circular diameter.

In one possible embodiment, the leg bars are arranged so that the upper and lower cover surfaces each form a triangle. The base of each triangle is formed by a part of a corner post. Preferably, leg bars of a cover surface are connected to the corner post at an acute angle and, in particular, form an isosceles triangle.

The cross-connecting structures can be designed as prismatic structures (this does not preclude the upper and lower cover surfaces from not being completely parallel to one another), wherein the upper and lower cover surfaces are each designed as triangles, in particular as isosceles triangles. The triangles or prismatic structures are preferably directly adjacent to each other in the longitudinal direction (i.e. the space between two neighbouring cross-connecting structures is preferably also triangular (in plan view), so that a cross-connecting structure of the other lattice piece part can be accommodated therein in the transport position.

In another possible embodiment, it is provided that the connection means are arranged at the “tips” of said triangles facing away from the side surfaces. In the assembled state, the tips of the cross-connecting structures, which are triangular in plan view, are therefore arranged next to each other and connected to each other via the connection means. Preferably, connection means are arranged on both the lower and upper cover surfaces.

In another possible embodiment, it is provided that the cross-connecting structures have a trapezoidal cross-section or a trapezoidal outer contour when viewed in the longitudinal direction (i.e. along the corner posts), wherein the distance between the upper and lower leg bars at the ends facing away from the side surface is less than the distance between the corner posts. The lower height of the cross-connecting structures at their ends facing away from the side surfaces results from the inclination of the upper and/or lower cover surface. Preferably, both cover surfaces are inclined so that the cross-sections or outer contours of the cross-connecting structures form a symmetrical trapezoid when viewed in the longitudinal direction. This makes it possible to provide longitudinal bars on the upper and lower cover surfaces and to slide the lattice piece parts into each other for transport.

In another possible embodiment, it is provided that the lattice piece parts comprise exactly two cross-connecting structures in each case and can preferably be connected to one another in plan view at two points (in particular at the tips of the aforementioned triangular or prismatic cross-connecting structures) via connection means. The lattice piece is therefore not statically overdetermined and constrained. A smaller number of components are required for the lattice piece, thus reducing its weight. This is advantageous in particular for the erectability of long boom systems with a main boom. Furthermore, production costs are reduced as fewer weld seams are required. However, it is of course conceivable to provide more than two (for example three or four) cross-connecting structures per lattice piece part to form longer lattice pieces.

In another possible embodiment, it is provided that the longitudinal axes of the leg bars of the upper and lower cover surfaces and the longitudinal axes of the respective corner posts intersect. The leg bars are therefore not offset to the respective corner posts. The reduced height of the cross-connecting structures at their ends facing away from the side surfaces results, in particular, purely from the inclination of the top surface(s) and not from an offset of the leg bars relative to the corner posts. This means that there is no additional offset moment in the corner posts that would have to be taken into account in structural calculations.

Preferably, the longitudinal axes of the at least one longitudinal bar and the longitudinal axes of the leg bars connected thereto do not intersect. In particular, at least one upper longitudinal bar is arranged above the upper cover surface and at least one lower longitudinal bar is arranged below the lower cover surface and is connected, in particular welded, to the leg bars there from the outside either directly or indirectly via intermediate pieces.

In another possible embodiment, it is provided that the at least one longitudinal bar is firmly connected to the respective leg bars via intermediate pieces. If a longitudinal bar is provided on the upper side of the lattice piece part (i.e. above the upper cover surface), then in particular all the upper leg bars of the cross-connecting structures are firmly connected to the longitudinal bar via intermediate pieces. If a longitudinal bar is provided on the lower side of the lattice piece part (i.e. below the lower cover surface), then in particular all the lower leg bars are firmly connected to the longitudinal bar via intermediate pieces.

Preferably, the intermediate pieces are designed as an elongated hollow profile, longitudinal axis of which runs parallel to the longitudinal axis of the longitudinal bar. The intermediate pieces are preferably designed as “horizontal” pipe sections, i.e. running parallel to the longitudinal bar, preferably with a cross-section that varies along their longitudinal axis (to accommodate the curvatures of the leg bar and longitudinal bar). This means that longer weld seams are possible at all connection points, which increases the load-bearing capacity of the connections between the intermediate piece and the longitudinal bar/leg bar. In particular, the connections are formed via welded joints, so that the horizontal arrangement of the intermediate pieces improves accessibility for the welding process and increases the length of the weld seams.

The use of a tube as an intermediate piece also offers further advantages over a component made using a different manufacturing process. The pipe can be manufactured in a single production step, as the component contour and seam preparations are burnt from the primary material in a single cut. In particular, it is manufactured from the same raw material and semi-finished product as the rest or at least large parts of the lattice structure, in particular as the longitudinal bar, and is therefore subject to the same manufacturing accuracy, material quality, material chemistry and other specifications.

In another possible embodiment, it is provided that only a single longitudinal bar is arranged on the upper and/or lower cover surfaces of a lattice piece part. Preferably, exactly one longitudinal bar is provided on the upper cover surface and exactly one longitudinal bar is provided on the lower cover surface. The longitudinal bar preferably runs substantially in the centre between the side surface and the ends of the cross-connecting structures facing away from the side surface (on which, in particular, the connection means are arranged). The longitudinal bar can be arranged somewhat closer to the corner post so that the lattice piece parts can be pushed together completely for the transport position. The longitudinal bar can run in a central third of the lattice piece part viewed in plan view between the corner post and the connection means, in particular in a central fifth.

The longitudinal bar has a load-bearing effect in particular, as it serves to stabilise the lattice piece as a whole and reduces the buckling length of the corner posts at right angles to the lattice piece. The closer the longitudinal bar can be placed to the centre axis of the lattice piece (i.e. at the ends of the cross-connecting structures facing away from the respective side surface), the lower the forces to be transmitted and the more filigree the individual connection points of the longitudinal bar to the leg bars (which are preferably realised via the intermediate pieces described above) can be. The lattice piece parts should be able to be pushed into each other as far as possible during transport. This requires a certain minimum distance between the longitudinal bar and the centre axis of the lattice piece. For this reason, placing the longitudinal bar in the centre or substantially in the centre of the cross-connecting structures offers a good compromise between stability and transport width of the lattice piece.

In another possible embodiment, it is provided that the connection means represent or comprise fork-finger connection points formed by sheet metal structures arranged at the inner ends of the cross-connecting structures opposite the side surfaces. To connect the lattice piece parts, the fork-finger connection points are pushed into each other and connected with bolts.

Preferably, the sheet metal structures that form the fork-finger joints are housed and welded in end pieces connected to the leg bars. These end pieces, which are in particular designed as tubular pieces, can connect the ends of the leg bars facing away from the side surfaces and represent the facing ends of the cross-connecting structures (in particular the “tips” of triangular or prismatic cross-connecting structures). Preferably, the sheet metal structures are not accommodated in a single recess in the respective end piece, but in two opposing recesses and protrude through the respective end piece. As a result, the sheet metal structures are welded at two points in the end piece, making them much more stable. The recesses can be rectangular.

The sheet metal structures can penetrate the respective end piece with different cross-sections. Pushing through the sheet metal structures for the fork-finger connections of the cross-connections of the lattice piece results in the load being distributed over two circumferential weld seams instead of a single circumferential weld seam. This provides advantages in terms of production and static dimensioning.

In another possible embodiment, it is provided that the corner posts are firmly connected to one another at their ends via posts and between the posts via a plurality of diagonal and unstrained bars. The posts and unstrained bars each represent vertical bars (these are defined here as bars whose longitudinal axes run perpendicular to the longitudinal axes of the corner posts), wherein the posts delimiting the side surfaces in the longitudinal direction transmit forces from the longitudinal connections of the lattice piece with neighbouring lattice pieces, whereas the unstrained bars arranged between the posts in particular do not transmit any forces. The corner posts, posts, diagonal bars and unstrained bars are used to span the side panes or side surfaces of the lattice piece as a flat support structure in particular.

Preferably, an unstrained bar is always arranged between two neighbouring diagonal bars so that the unstrained bars alternate. The unstrained bars reduce the buckling length of the corner posts in the direction of the side surfaces from one diagonal bar to the next.

In another possible embodiment, the cross-connecting structures comprise a plurality of diagonal and vertical bars to increase their stability. The upper leg bars forming the upper cover surface and the lower leg bars forming the lower cover surface of a cross-connecting structure are firmly connected to each other via a plurality of diagonal and vertical bars. The aforementioned vertical bars can comprise unstrained bars and/or posts (which transfer forces from the cross-connections between the lattice piece parts). In the case of triangular cover surfaces, the upper and lower leg bars can be connected to each other at the “tips” of the triangles via a post.

With additional unstrained bars, the buckling length of the leg bars is reduced (if placed in the centre, the buckling length is halved). One unstrained bar and one diagonal bar on each side of a cross-connecting structure (which is spanned by an upper and lower leg bar) can be provided. This results in stable flat support structures that form the side surfaces of the cross-connecting structures.

Preferably, the leg bars are firmly connected to the corner posts via additional diagonal bars, the longitudinal axes of which lie within the upper or lower cover surface. These reduce the buckling length of the leg bars.

In another possible embodiment, it is provided that at least one of the lattice piece parts comprises retaining connection means to which connection means of the other lattice piece part can be releasably connected in a transport position in which the lattice piece parts are pushed into one another. The retaining connection means can represent or comprise fork-finger connection points, which can be connected to corresponding fork-finger connection points of the connection means via bolts. This allows the two lattice piece parts to be connected or locked together in the pushed together transport position such that they cannot come apart unintentionally.

In another possible embodiment, it is provided that the retaining connection means are arranged at the ends of the corner posts or at the ends of posts connecting the corner posts. Preferably the cross-connecting structures are designed in such a way and the connection means and retaining connection means are arranged in such a way that, in a state in which they have a retaining connection between connection means and retaining connection means at only one end, the lattice piece parts can be pivoted into one another about a pivot axis formed by this connection in order to pivot the connection means and retaining connection means together at the opposite end.

This results in a simplified assembly and disassembly process. To convert the lattice piece for the transport position, it may be necessary to move only one of the lattice piece parts while the other lattice piece part remains stationary. Any lifting gear used for this purpose (e.g. an assembly crane) can be connected to attachment points on the upper corner post of one of the lattice piece parts and lift this lattice piece part in order to relieve the connection means on the cross-connections between the lattice piece parts. After the bolts have been pulled (if the connection means are designed as fork-finger connections), the attached (first) lattice piece part is moved away from the other (second) lattice piece part and completely lifted and moved relative to the second lattice piece part in such a way that the connection means of the first lattice piece part overlap with the retaining connection means of the second lattice piece part at one end and a first retaining connection can be made (in particular by bolting).

After closing this first retaining connection, the lifted first lattice piece part is pivoted with the lifting gear about the pivot axis, which is formed by the first retaining connection, to the stationary lattice piece part and the second retaining connection is established. This means that no personnel need to climb into the lattice piece to close it (forming and locking the transport position), as the connection points of the retaining joints on the end faces of the transport unit (i.e. the lattice piece in the transport position) are accessible. Being able to close the retaining connections one after the other is also more convenient than having to align all the connection means and retaining connection means at the same time.

The invention also relates to a lattice boom with a lattice piece according to the invention. The lattice boom can comprise a plurality of lattice pieces according to the invention. These can be connected to each other via longitudinal connection means arranged on the corner posts, which can be designed as fork-finger connection points.

The invention also relates to a working machine with a lattice boom according to the invention. This may be a crane, in particular a mobile crane such as a crawler crane. The working machine preferably comprises an undercarriage having a chassis, in particular a crawler chassis, and an upper carriage mounted on the undercarriage so that it can rotate about a vertical axis of rotation. The lattice boom according to the invention is mounted on the upper carriage such that it can luff about a horizontal luff axis. The working machine can furthermore have a derrick boom mounted on the upper carriage. Preferably, the lattice boom according to the invention forms the main boom of the working machine. Further attachments, such as a fixed tip, can be fitted to this.

### BRIEF DESCRIPTION OF THE FIGURES

Further features, details and advantages of the invention result from the following exemplary embodiments explained with the help of the figures. In the drawings:

FIG. 1: shows a perspective view of an exemplary embodiment of the lattice piece according to the invention in the assembled state;

FIGS. 2-3: show side views of the lattice piece;

FIG. 4: shows a perspective view of a connection means of the lattice piece;

FIG. 5: shows a side sectional view of two bolted connection means of the lattice piece;

FIG. 6: shows a perspective view of the lattice piece in the transport position;

FIG. 7: shows a perspective view of the lattice piece when the lattice piece parts are pivoted together;

FIG. 8: shows a side sectional view of the lower and upper retaining connections in the bolted state;

FIG. 9: shows a perspective view of an intermediate piece; and

FIG. 10: shows a side view of a working machine according to the invention according to an exemplary embodiment.

### DETAILED DESCRIPTION

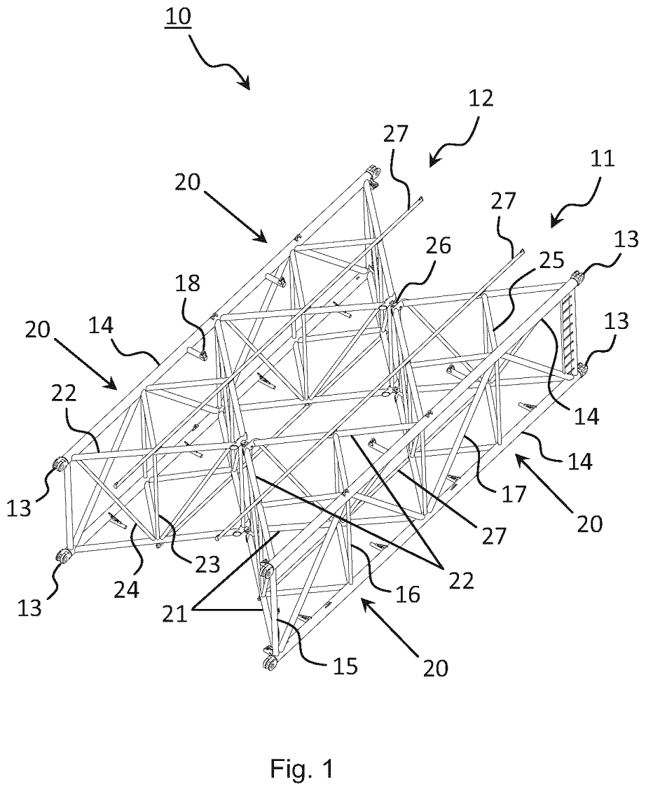

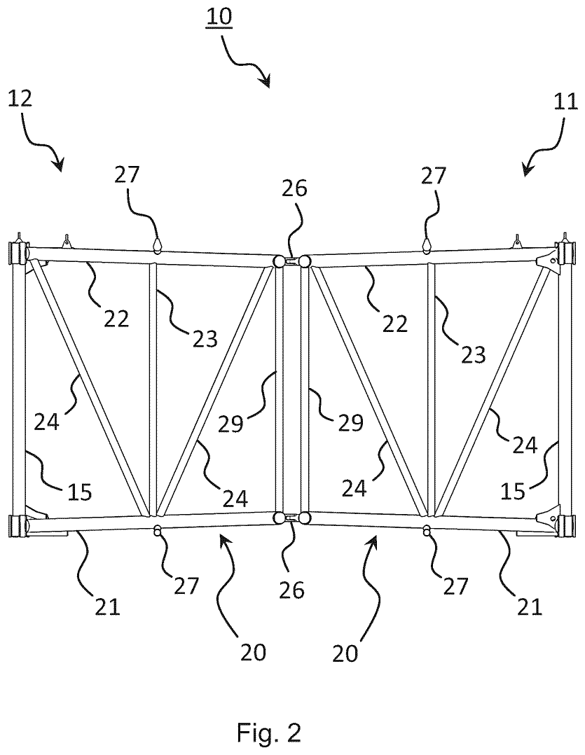

FIG. 1 shows a perspective view of an exemplary embodiment of the longitudinally divisible lattice piece 10 according to the invention. The lattice piece 10 comprises two lattice piece parts 11, 12 that can be detachably connected to one another via a plurality of connection means 26 and can also be referred to as lattice piece halves. The two lattice piece parts 11, 12 preferably have a symmetrical structure (with respect to an imaginary centre plane running in the longitudinal direction). A side view looking along the longitudinal axis of the lattice piece 10 is shown in FIG. 2.

Each lattice piece part 11, 12 comprises two corner posts 14, which extend in the longitudinal direction of the lattice piece 10 and can be formed as hollow profiles. The corner posts 14 can have longitudinal connecting means 13 at their front ends in the form of fork-finger connection points, via which the lattice piece 10 can be connected to further lattice pieces 10 according to the invention and/or to other lattice pieces. The corner posts 14 are firmly connected to each other via a plurality of diagonal bars 17 and vertical bars 15, 16 running perpendicular to the corner posts 14. Two posts 15 can be provided as vertical bars, which connect the corner posts 14 to each other in the area of the longitudinal connecting means 13 and transmit the forces of these fork-finger connections. A plurality of unstrained bars 16 can also be provided as vertical bars, which are arranged between the diagonal bars 17.

As indicated in FIG. 3, the imaginary longitudinal axes of the corner posts 14 and the diagonal and vertical bars 15, 16, 17 lie in a common plane and span an imaginary side surface 30 of the lattice piece 10.

The lattice piece parts 11, 12 each comprise a plurality of cross-connecting structures 20 on which the connection means 26 for the cross-connections are arranged. In the exemplary embodiment shown, the cross-connecting structures 20 form prismatic truss structures with a triangular base. The cross-connecting structures 20 each comprise two lower leg bars 21, which are firmly connected to the lower corner post 14, and two upper leg bars 22, which are firmly connected to the upper corner post 14. The lower leg bars 21 of a cross-connecting structure 20 extend at an acute angle to the lower corner post 14 and converge at a point facing away from the side surface 30, so that their longitudinal axes and the longitudinal axis of the lower corner post 14 form an imaginary lower cover surface 31 (see FIG. 3). Similarly, upper leg bars 22 of a cross-connecting structure 20 extend at the same acute angle to the lower corner post 14 and converge at a point facing away from the side surface 30, so that their longitudinal axes and the longitudinal axis of the upper corner post 14 form an imaginary upper cover surface 32 (see FIG. 3). In this exemplary embodiment, the upper and lower cover surfaces 31, 32 are triangular and congruent.

As can be seen in FIG. 2, the connection means 26, which form the detachable cross-connecting structures of the lattice piece parts 11, 12, are arranged at the “tips” of the prismatic cross-connecting structures 20 formed by the upper and lower leg bars 21, 22. The lattice piece 10 of this exemplary embodiment has exactly two cross-connecting structures 20 per lattice piece part and thus a total of four connection means 26 (at two different positions in plan view). However, more than two cross-connecting structures 20 per lattice piece part 11, 12 or more than four connection means 26 could be provided.

On each side surface of the prismatic structure, the cross-connecting structures 20 also have diagonal and vertical bars 23, 24, 29, which firmly connect the lower and upper leg bars 21, 22 to each other on each side (see FIG. 3). A post 29 can connect the tips of the upper and lower leg bars 21, 22 in the region of the connection means 26. A further unstrained bar 23 may be provided substantially centred on the side surfaces of the cross-connecting structures 20. On each side of the unstrained bar 23, a diagonal bar 24 can connect the lower and upper leg bars 21, 22. This results in lattice-like side surfaces of the cross-connecting structures 20, which gives them greater stability and reduces the buckling lengths of the leg bars 21, 22.

The upper leg bars 22 of two interconnected cross-connecting structures 20 of the connected lattice piece 10 can run coaxially, as can the respective lower leg bars 21. As can be seen in FIG. 1, the upper leg bars 22 (and correspondingly the lower leg bars 21) of the connected lattice piece 10 thus form in particular an “X” or, in the case of two cross-connecting structures 20 per lattice piece part 11, 12, two “X”s arranged next to each other. In the centre of the connected lattice piece 10, this can result in an intermediate space with a square base area (in plan view).

As can also be seen in FIG. 1, the upper leg bars 22 can be connected to the upper corner post 14 via further diagonal bars 25, the longitudinal axes of which extend within the upper cover surface 32, in order to reduce the buckling length of the leg bars 22 within this plane, and similarly the lower leg bars 21.

Each lattice piece part 11, 12 may comprise two longitudinal bars 27 that extend parallel to the corner posts 14 and are firmly connected to the leg bars 21, 22 in order to reduce the buckling length of the corner posts 14 and increase the stability of the lattice piece 10. An upper longitudinal bar 27 preferably extends above the upper cover surface 32 and is connected to the upper leg bars 22 via end pieces 38 described in more detail below (see FIG. 2). A lower longitudinal bar 27 preferably extends below the lower cover surface 31 and is also connected to the lower leg bars 21 via end pieces 38 (see FIG. 2). Alternatively, a plurality of upper and lower longitudinal bars 27 could be provided.

The longitudinal bars 27 are preferably arranged approximately centrally between the side surfaces 30 and the imaginary centre plane of the lattice piece 10, which runs through the connection means 26.

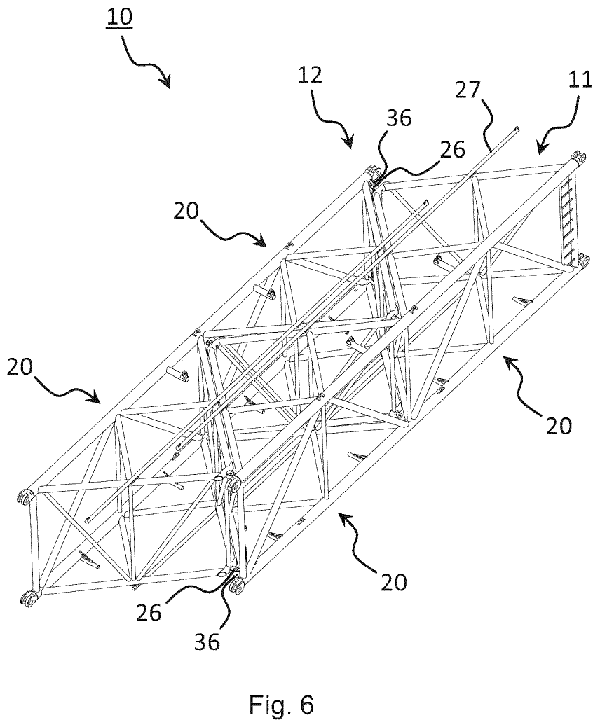

In order to comply with the legally prescribed transport dimensions, in particular a maximum transport width, the lattice piece 10 can be divided longitudinally at the central connection means 26, i.e. the two lattice piece parts 11, 12 can be detached from each other. Due to the shape of the cross-connecting structures 20, the lattice piece parts 11, 12 can be offset to each other in the longitudinal direction and pushed into each other in the transverse direction, so that the cross-connecting structures 20 of the various lattice piece parts 11, 12 are nested and interlocked. Such a transport state is shown in FIG. 6.

To ensure that such interlocking is possible despite the longitudinal bars 27, the upper and lower leg bars 21, 22 do not run parallel to each other, but are slightly inclined towards each other. In other words, the upper and lower cover surfaces 31, 32 are not perpendicular to the side surface 30, but are slightly inclined towards each other (see FIG. 2-FIG. 3). As a result, the distance between the upper and lower leg bars 21, 22 at the tips of the cross-connecting structures 20 is less than the distance between the corner posts 14. This allows the cross-connecting structures 20 to be pushed into each other to form the transport position despite the longitudinal bars 27.

As an alternative to the exemplary embodiment shown in FIG. 3, a longitudinal bar 27 could be arranged on only one of the cover surfaces and only this cover surface could be inclined, while the other cover surface is perpendicular to the side surface 30. Alternatively, both cover surfaces 31, 32 could be inclined at different angles. However, a design such as that shown in FIG. 3, in which the side cross-sections of the cross-connecting structures 20 form symmetrical trapezoids, is preferred.

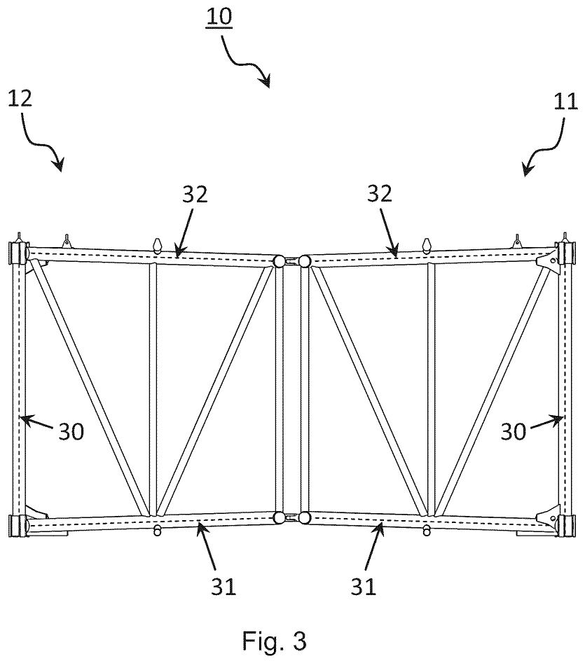

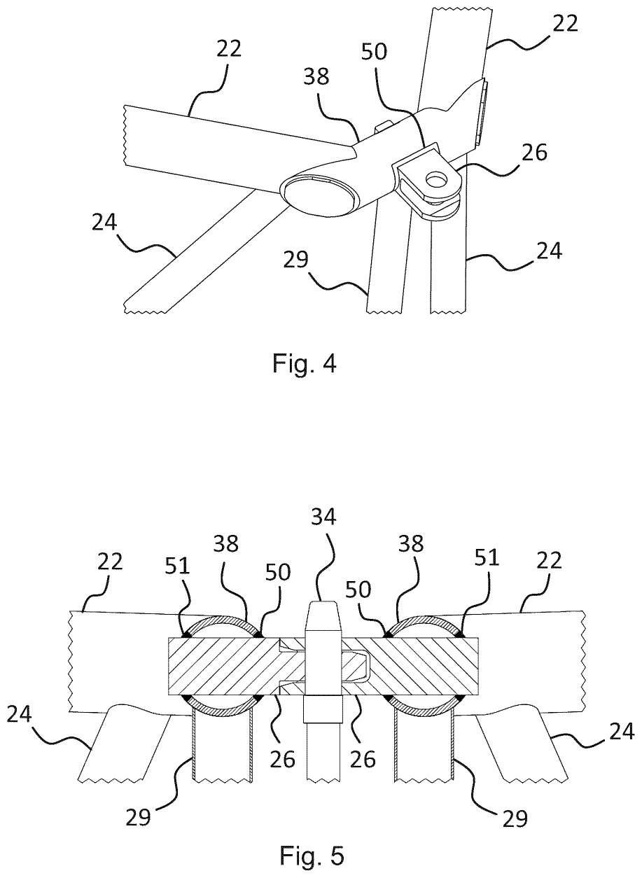

FIG. 4 shows a tip of a cross-connecting structure 20 with the associated connection means 26. The latter can be designed as a fork-finger connection point (in the example of FIG. 4 as a fork, wherein the corresponding connection means 26 of the other lattice piece part is designed as a finger), which is formed by a corresponding sheet metal structure. The ends of the (here upper) leg bars 22 facing away from the side surface 30 are connected to each other via a preferably tubular end piece 38. In FIG. 5, two connection means 26 of the two lattice piece parts 11, 12 bolted together are shown in a side view as a section through the connection means 26. These are shown bolted together by a bolt 34.

In the assembled state, the end piece 38 has a first recess pointing towards the connection means 26 of the other lattice piece part and a second recess pointing towards the side surface 30. The sheet metal structure forming the connection means 26 is inserted through both recesses and extends through the end piece (see FIG. 5). As a result, the sheet metal structure of the connection means 26 is welded not just to one recess, but to two recesses in the end piece 38, making it more stable in the end piece. In particular, the sheet metal structure is welded to the end piece 38 at the front recess with a circumferential front weld seam 50 and at the rear recess with a circumferential rear weld seam 51.

All bars or tubes 14, 15, 16, 17, 21, 22, 23, 24, 25, 28, 38 of a lattice piece part 11, 12 are preferably welded together.

The lattice piece parts 11, 12 may comprise a plurality of retaining connection means 36 to which the connection means of the other lattice piece part 11, 12 may be connected in the transport position in order to secure or lock the lattice piece parts 11, 12 in the transport position. Preferably, the retaining connection means 36, like the connection means 26, are fork-finger connection points.

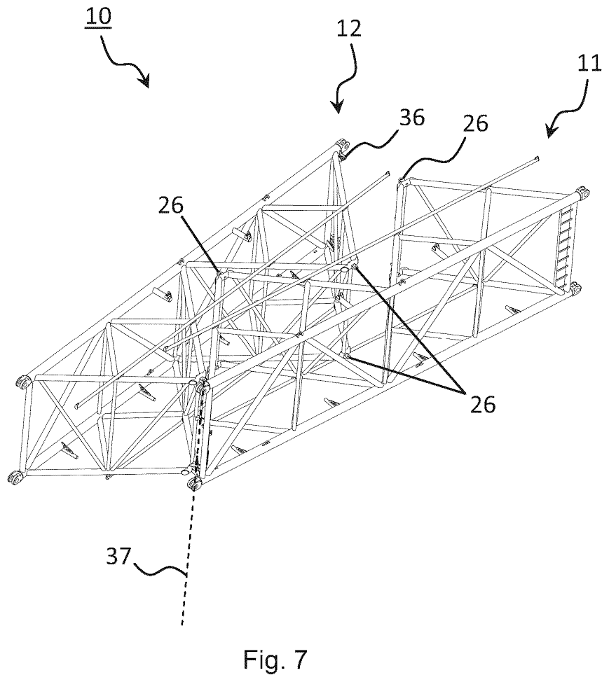

FIG. 7 shows an exemplary embodiment in which each lattice piece part 11, 12 has two retaining connection means 36 at one longitudinal end, which are arranged in the region of the ends or longitudinal connection means 13 of the corner posts 14. The retaining connection means 36 can be connected, in particular welded, to the corner posts 14 or to a post 15 there, or to both.

It may be provided that only the connection means 26 of one of the cross-connecting structures 20 are connected to the retaining connection means 36 of the other lattice piece part 11, 12 (see FIG. 7).

The connection means 26 and retaining connection means 36 are in particular bolted together. Preferably, the same bolts 34 are used for this purpose as for connecting the connection means 26 to one another. In particular, the bolts 34 are arranged coaxially to one another (one above the other) in the connected state and form a pivot axis 37 about which the two lattice piece parts 11, 12 can be pivoted as long as they are only connected at one end. FIG. 7 shows the situation in which the lattice piece parts 11, 12 are bolted together at only one of their ends via the connection means 26 and retaining connection means 36 and can be pivoted relative to one another about the pivot axis 37 formed by this first retaining connection.

One of the lattice piece parts 11, 12 (for example the first lattice piece part 11 shown on the right in FIG. 7) can be lifted by an assembly crane and pivoted about the pivot axis 37 towards the other, second lattice piece part 12, so that the cross-connecting structures 20 move into one another. The lattice piece parts 11, 12 can have a plurality of attachment points 18 on the corner posts 14 for lifting by an assembly crane (see FIG. 1). As soon as the connection means 26 and retaining connection means 36 at the other end of the lattice piece parts 11, 12 overlap, they can be bolted together, thus creating the second retaining connection.

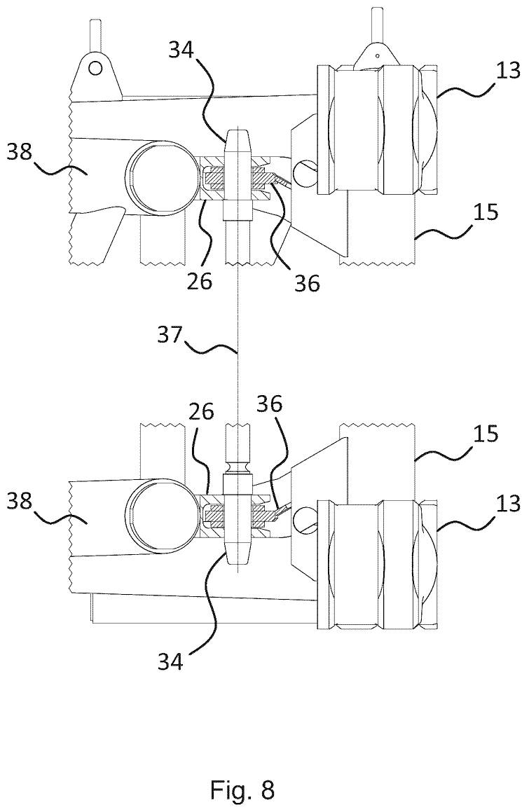

FIG. 8 shows a section through the upper and lower retaining connection means 36 of one end of a lattice piece part 11, 12 transversely to the longitudinal direction, wherein the section of the lattice piece part 11, 12 in between is not shown. It can be seen that the bolts 34 are arranged coaxially.

Preferably, corresponding bolt insertion devices are arranged between the connection means 26 on the cross-connecting structure 20, which carries the connection means 26 that can be bolted to the retaining connection means 36. These can be connected to a post 29 connecting the upper and lower leg bars 21, 22. The bolt insertion devices may comprise actuators (not shown) that allow movement of the bolts 34 to release or insert the transverse or retaining connections. Accordingly, the bolts 34 can be connected to bars, which in turn can be moved along the imaginary pivot axis 37 via the aforementioned actuators. This means that no human personnel need to set or release the bolts 34 by hand, which considerably simplifies the assembly and disassembly process.

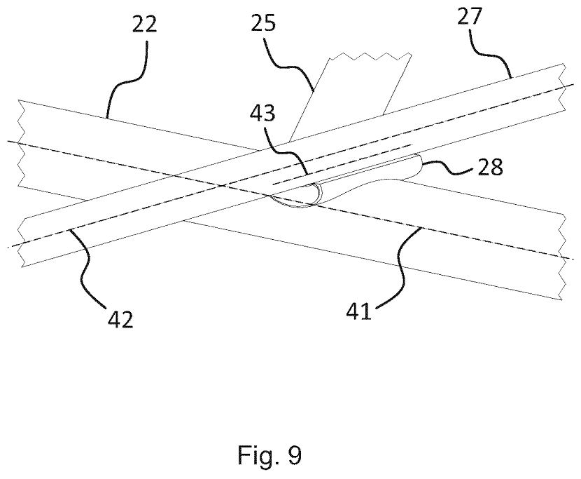

FIG. 9 shows an intermediate piece 28, via which the upper longitudinal bar 27 of a lattice piece part 11, 12 is connected to an upper leg bar 22. The intermediate piece 28 is preferably designed as a tubular piece, the longitudinal axis 43 of which runs parallel to the longitudinal axis 42 of the longitudinal bar 27. Due to this parallel arrangement of the tubular intermediate piece 28, longer weld seams are possible at the connection points to the leg bar 22 or to the longitudinal bar 27, the accessibility of which is also improved compared to tubular pieces standing perpendicular to the longitudinal and leg bars 22, 27. As show, the cross-section of the intermediate piece 28 can vary along its longitudinal axis 43 in order to adapt its contour to the curvatures of the leg bar 22 and the longitudinal bar 27.

Furthermore, FIG. 9 shows that by using intermediate pieces 28, the longitudinal bars 27 do not run inside the respective cover surfaces 31, 32, but above them (or below them on the lower cover surface 31). Thus, the longitudinal axes 42 of the longitudinal bars 27 do not intersect the longitudinal axes 41 of the leg bars 21, 22.

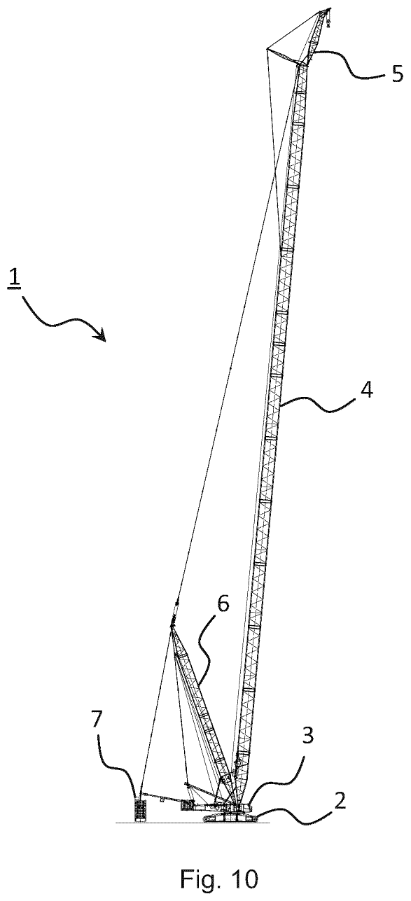

FIG. 10 shows a side view of an exemplary embodiment of the working machine 1 according to the invention, which comprises a boom 4 having one or more lattice pieces 10 according to the invention. The working machine of the exemplary embodiment in FIG. 10 is a crawler crane 1 with an undercarriage 2 with crawler chassis and an upper carriage 3 mounted on the undercarriage 2 so as to rotate about a vertical axis of rotation, to which the boom 4 is pivoted about a horizontal luff axis. The boom 4 is the main boom and can carry a fixed tip 5. The crawler crane 1 can have a derrick boom 6 and a derrick ballast 7.

### LIST OF REFERENCE NUMERALS

1 Working machine
2 Undercarriage
3 Upper carriage
4 Boom
5 Fixed tip
6 Derrick boom
7 Derrick ballast
10 Lattice piece
11 First lattice piece part
12 Second lattice piece part
13 Longitudinal connection means
14 Corner post
15 Post
16 Unstrained bar
17 Diagonal bar
18 Attachment point
20 Cross-connecting structure
21 Lower leg bar
22 Upper leg bar
23 Unstrained bar
24 Diagonal bar
25 Diagonal bar
26 Connection means
27 Longitudinal bar
28 Intermediate piece
29 Post
30 Side structure
31 Lower cover surface
32 Upper cover surface
34 Bolt
36 Retaining connection means
37 Pivot axis
38 End piece
41 Longitudinal axis of leg bar
42 Longitudinal axis of longitudinal bar
43 Longitudinal axis of intermediate piece
50 Front weld seam
51 Rear weld seam

1. Longitudinally divisible lattice piece for a lattice boom, comprising two detachably connectable lattice piece parts that can be detached from one another for transport and pushed into one another transversely to the longitudinal direction, wherein each of the lattice piece parts comprises two corner posts extending in the longitudinal direction, which are firmly connected to one another via a plurality of diagonal and vertical bars and together with these define a side surface of the lattice piece, and at least two cross-connecting structures firmly connected to the corner posts, wherein the lattice piece parts can be detachably connected via connection means arranged on the cross-connecting structures,
wherein
the cross-connecting structures each comprise at least two leg bars, which are firmly connected to an upper corner post of a lattice piece part and at least two leg bars, which are firmly connected to a lower corner post of the lattice piece part and which, together with the respective corner post, define an upper and a lower cover surface of the lattice piece, wherein the upper and lower cover surfaces are inclined relative to a plane perpendicular to the side surface towards the other cover surfaces and their leg bars are connected via at least one longitudinal bar extending parallel to the corner posts.

2. Lattice piece according to claim 1, wherein the leg bars are arranged such that the upper and lower cover surfaces form triangles, wherein one or more leg bars of a cover surface are connected to the corner post at an acute angle.

3. Lattice piece according to claim 2, wherein the connection means are arranged at the tips of the triangles facing away from the side surfaces, wherein connection means are arranged on both the lower and the upper cover surfaces.

4. Lattice piece according to claim 1, wherein the cross-connecting structures have a trapezoidal cross-section when viewed in the longitudinal direction, wherein the distance between the leg bars of the upper and lower cover surfaces at the ends facing away from the side surface is less than the distance between the corner posts, wherein the cross-sections form a symmetrical trapezoid.

5. Lattice piece according to claim 1, wherein the lattice piece parts comprises exactly two cross-connecting structure and in plan view can be connected to each other at two points via connection means.

6. Lattice piece according to claim 1, wherein the longitudinal axes of the leg bars of the upper and lower cover surfaces and the longitudinal axes of the respective corner posts intersect, wherein the longitudinal axes of the at least one longitudinal bar and the longitudinal axes of the leg bars do not intersect.

7. Lattice piece according to claim 1, wherein the at least one longitudinal bar is firmly connected to the respective leg bars via intermediate pieces, wherein the intermediate piece is formed as an elongate hollow profile, the longitudinal axis of which runs parallel to the longitudinal axis of the longitudinal bar and the cross-section of which varies along its longitudinal axis.

8. Lattice piece according to claim 1, wherein only a single longitudinal bar is arranged on each of the upper and/or lower cover surfaces of a lattice piece part, which bar preferably extends substantially centrally between the side surface and the ends of the cross-connecting structures facing away from the side surface.

9. Lattice piece according to claim 1, wherein the connection means comprise fork-finger connection points that are formed by sheet metal structures arranged at the inner ends of the cross-connecting structures opposite the side surfaces and, are received and welded in end pieces connected to the leg bars, wherein the sheet metal structures are in two opposing recesses of the end pieces and project through the end pieces.

10. Lattice piece according to claim 1, wherein the corner posts are firmly connected to one another at the ends via posts and between the posts via a plurality of diagonal and unstrained bars, wherein the diagonal and unstrained bars alternate.

11. Lattice piece according to claim 1, wherein the upper leg bars forming the upper cover surface and the lower leg bars forming the lower cover surface of a cross-connecting structure are firmly connected to one another via a plurality of diagonal and vertical bars, wherein the leg bars are firmly connected to the corner posts via additional diagonal bars, the longitudinal axes of which lie within the upper or lower cover surface.

12. Lattice piece according to claim 1, wherein at least one of the lattice piece parts comprises retaining connection means to which connection means of the other lattice piece part can be releasably connected in a transport position in which the lattice piece parts are pushed into one another, wherein both lattice piece parts each comprise at least two retaining connection means.

13. Lattice piece according to claim 12 the preceding claim, wherein the retaining connection means are arranged at the ends of the corner posts or on posts connecting the ends of the corner posts, wherein the cross-connecting structures are designed in such a way and the connection means and retaining connection means are arranged in such a way that, in a state in which they have a connection between connection means and retaining connection means at only one end, the lattice piece parts can be pivoted into one another about a pivot axis formed by this connection in order to pivot the connection means and retaining connection means [[(36)]] together at the other end.

14. Lattice boom having at least one lattice piece according to claim 1.

15. Working machine, having a lattice boom according to claim 14, wherein the working machine comprises an undercarriage with a chassis, an upper carriage mounted on the undercarriage so as to rotate about a vertical axis of rotation, and the lattice boom is mounted on the upper carriage so as to luff about a horizontal luff axis.
